(19) United States
(12) Patent Application Publication
(10) Pub. No.: US 2020/0180120 A1
(43) Pub. Date: Jun. 11, 2020

(54) UNIVERSAL SINGLE PERSON UNDERMOUNT FIXTURE INSTALLATION DEVICE AND METHOD OF USING SAME

(71) Applicants: Thomas Kosik, SR., Pelham, NH (US); Dario Correia, Georgetown, MA (US); Norman Fine, Charlestown, MA (US)

(72) Inventors: Thomas Kosik, SR., Pelham, NH (US); Dario Correia, Georgetown, MA (US); Norman Fine, Charlestown, MA (US)

(21) Appl. No.: 16/214,089

(22) Filed: Dec. 9, 2018

(51) Int. Cl. B25B 11/02; E03C 1/33

(52) U.S. Cl. CPC B25B 11/02; E03C 1/33

(57) ABSTRACT

The “Tool/Device” is for the installation of fixtures or similar appurtenances which need to be raised through a pre-made opening to the underside of the substrate to which they would attach/secure to. The “Tool/Device” is placed, spanning an opening by means of a stationary and or adjustable support. The support houses the operating features to raise and lower “fixtures” into their final secured position. The “fixture” is attached to the device by means of a sized support which can protrude the fixture for raising and or lowering. The sized support is attached to a shaft/tether which is controlled by manual function through the operating features.

### FIELD OF THE INVENTION

The present invention relates to the plumbing industry. More particular, the invention relates to the placement and installation of undermount “fixtures” such as lavatories and kitchen sinks to the underside of countertops, in preparation for final securing.

The inventors of this device represent different facets of the commercial plumbing industry. Thomas Kosik has been a union plumber and project manager for over 35 years and has seen firsthand the need for this type of device to assist with the installation of plumbing fixtures. Norman has over 30 years in the industry as a commercial salesman for one of the largest plumbing vendors in the country. He has sold countless undermount fixtures and devices but has never sold or seen a device to assist with the installation of undermount fixtures. Dario Correia has an engineering and project management background and is constantly working on implementing and improving installation technology, devices and methods to combat the compressed schedules the industry is now facing. Together, this team is confident that the product we are presented herein is an industry necessity, is unique, marketable on a large scale and of sound engineering design and capability.

### BACKGROUND OF THE INVENTION

Installing undermount fixtures is typically a two-person activity. Once the countertop hole [1] is developed, the fixture [3] is ready for installation. Installer 1 will reach through the opening and grasp the fixture [3], raising it into place against the underside of the substrate [2] for attaching. While Installer 1 maintains the position of the fixture, Installer 2 will gain access to the cabinet or opening underneath the fixture and substrate for final fastening. This current state of this installation is labor intense, cumbersome, inefficient and crowded with 2 installers in a very tight area.

Certain installers have suggested the use of a brace or bracket to support the fixture once it is raised into place against the underside of the countertop. This method allows for installation with 1 installer but has considerable draw backs. The use of a support from the underside of the fixture [3] prevents access to make final necessary connections underneath the fixture [3] and often time delays the installation process. The conditions below an undermount fixture vary based on the installation environment and this method is not a universal solution such as the one we have invented. Another drawback is that when using a single installer with support from below, the alignment of the fixture within the opening cannot be verified from above as it is secured into place. This increases the margin of error for proper alignment of the fixture and may increase installation time if the process needs to be repeated. Therefore, a need exists in the field of plumbing/construction installations for a universal single person undermount fixture installation device.

### BRIEF SUMMARY OF THE INVENTION

Using this undermount fixture installation device provides universal installation capability for a single person. The device is placed over the countertop/substrate opening and the fixture is placed below the opening in the cabinet's base. The device includes a shaft which is lowered through the counter opening, into and through the fixture drain opening. A device on the end of the shaft then engages and supports the underside of the fixture through the drain opening to allow for the raising and lowering of the fixture with ease. The ergonomic design and operating features can raise the fixture to the underside of the substrate, assure proper alignment on the first try and secure the fixture in a hands-free state without any additional personnel, braces or brackets supporting the fixture from below when completing the installation.

### BRIEF DESCRIPTION OF THE DRAWINGS

FIG. 1—Depicts the conceptual design of the sized support which attaches to the shaft end for various fixture types and drain sizes.

FIG. 2—Depicts the conceptual design front view of the universal single person undermount fixture installation device and method in its initial state on top of the substrate and connected to the fixture.

FIG. 3—Depicts the conceptual transparent front view of the universal single person undermount fixture installation device and method in its initial state on top of the substrate and connected to the fixture.

FIG. 4—Depicts the conceptual design isometric view of the universal single person undermount fixture installation device and method in its working state on top of the substrate and connected to the fixture.

FIG. 5—Depicts the conceptual transparent isometric view of the universal single person undermount fixture installation device and method in its working state on top of the substrate and connected to the fixture.

FIG. 6—Depicts the conceptual design isometric view of the universal single person undermount fixture installation device and method in its final state on top of the substrate with the fixture fully installed.

FIG. 7—Depicts the conceptual transparent front view of the universal single person undermount fixture installation device and method in its final state on top of the substrate with the fixture fully installed.

FIG. 8—Depicts the conceptual design of the device described herein in isometric view.

FIG. 9—Depicts the conceptual design of the device described herein in front wireframe view.

FIG. 10—Depicts an image of working prototype device described herein.

FIG. 11—Depicts an additional image of the working prototype device described herein.

FIG. 12—Depicts an image of working prototype hand pull.

FIG. 13—Depicts an additional image of working prototype hand pull.

FIG. 14—Depicts the prototype of the sized support which attaches to the shaft end for various fixture types and drain sizes.

### DETAILED DESCRIPTION OF THE INVENTION

The single person undermount fixture device, FIG. 8 according to the present invention, is used to install a fixture or similar appurtenance designed for undermount attachment to a substrate. Once a countertop hole [1] is developed in the substrate [2], the undermount fixture [3] may be placed in the base of the cabinet. The appropriate installation sealant and clips may then be applied in accordance with manufacturers recommendations to the bottom of substrate [2] and or top of the fixture [3].

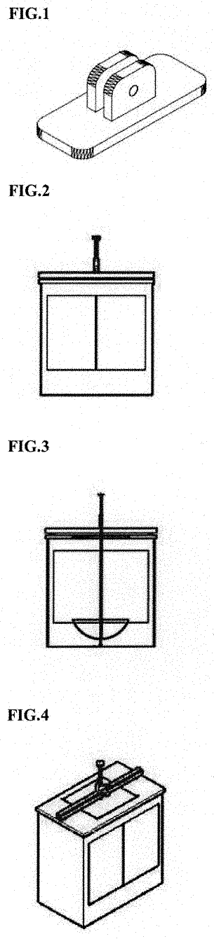

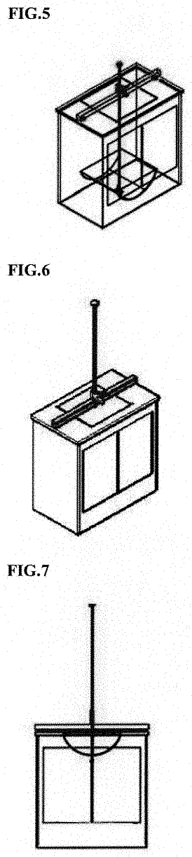

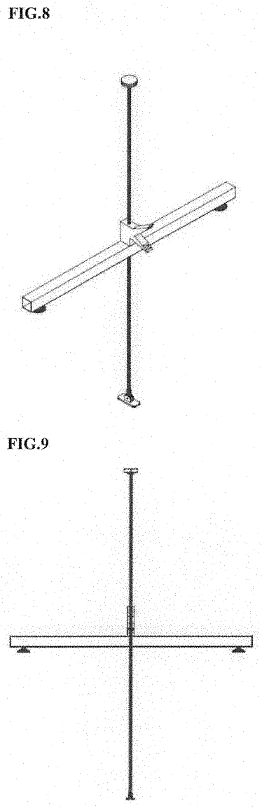

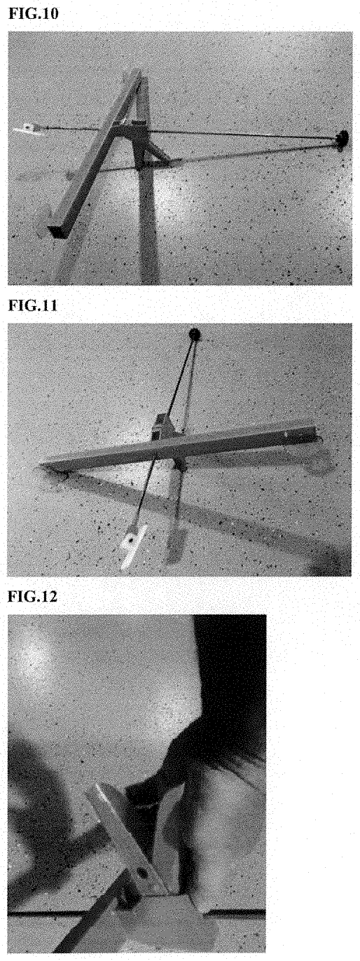

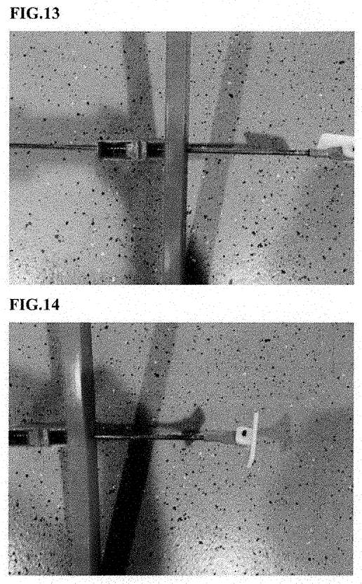

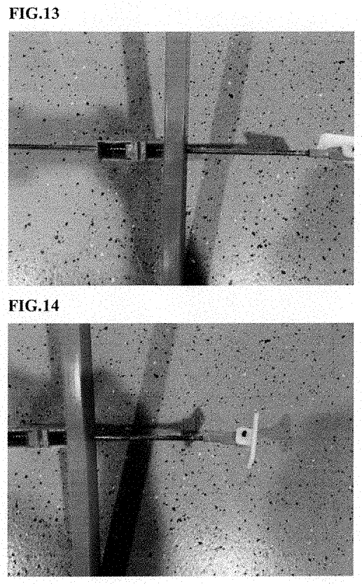

The device, FIG. 8, is placed on top of the substrate as indicated in FIG. 2. The device is secured via the suction cups, FIG. 4, to the substrate. The sized support, FIG. 1 & FIG. 14 which is installed on the bottom end of the shaft, FIG. 3, can then be inserted into the drain opening of the fixture [3]. Once inserted, the sized support FIG. 1, will swivel, making itself now large enough to fully engage and support the fixture. Installer 1 may now perform the initial raise indicated in FIG. 5, by pulling upwards on the shaft rod and pull. The manual hand pull/tight device, FIG. 12, will automatically engage the shaft rod and prevent the fixture from falling back down once pulled. Installer 1 may now adjust and assure proper alignment of the fixture [3] with the countertop hole [1]. Once assured, the final tight connection can be made via the hand pull FIG. 12 & FIG. 13. Once the fixture [3] is secured to the substrate [2]. The release lever on the hand pull can be trigged to release the rod and sized support back through the drain opening. This will disengage the sized support from the bottom of the drain and allow for swivel and retrieval of the sized support device from the top of the sink through the drain opening.

What is claimed is:

1. A universal undermount fixture installation device compromising: a stationary or adjustable support, shaft rod, pull, sized support, hand tight device wherein the support base with a hand tightening mechanism connects to a shaft rod which has a pull on one end and a sized support on the other.

2. The invention of claim 1 where the sized support is a secured to the shaft rod via a shear bolt or pin or other means of shear attachment allowing for rotation of the swivel device.

3. The invention of claim 1 where the pull is secured to the shaft rod via a threaded connection or other means of positive permanent or semi-permanent attachment.

4. The invention of claim 1 where the hand tight device is secured to the base via a welded connection or other means of positive permanent or semi-permanent attachment.

5. The invention of claim 1 where the support base is secured to a substrate via suction cups or other means of positive semi-permanent attachment.
